(19) United States
(12) Patent Application Publication
(10) Pub. No.: US 2018/0013109 A1
(43) Pub. Date: Jan. 11, 2018

(54) STEPPED BATTERY

(71) Applicant: LG CHEM, LTD., Seoul (KR)

(72) Inventors: Seung Seok BIN, Daejeon (KR); Ki Woong KIM, Daejeon (KR); Sung Han YOON, Daejeon (KR); Seong Hwan LEE, Daejeon (KR)

(73) Assignee: LG CHEM, LTD., Seoul (KR)

(21) Appl. No.: 15/544,099

(22) PCT Filed: Feb. 17, 2016
(86) PCT No.: PCT/KR2016/001621

§ 371 Date: Jul. 17, 2017

(30) Foreign Application Priority Data
Mar. 16, 2015 (KR) 10-2015-0036110

(51) Int. Cl. H01M 2/10; H01M 6/50; H01M 10/42

(52) U.S. Cl. CPC H01M 2/1061; H01M 10/425; H01M 6/5011; H01M 2220/30

(57) ABSTRACT

The present invention relates to a stepped battery, more particularly to, a stepped battery capable of increasing utilization of an inner space of a system. The stepped battery according to the present invention includes a first cell and a plurality of second cells, which are stacked on one surface of the first cell and each of which has a width less than that of the first cell. The second cells are disposed to be spaced apart from each other.

### TECHNICAL FIELD

The present invention relates to a stepped battery, and more particularly to, a stepped battery capable of increasing utilization of an inner space of a system.

### BACKGROUND ART

The present application claims the benefit of the priority of Korean Patent Application No. 10-2015-0036110, filed on Mar. 16, 2015, which is hereby incorporated by reference in its entirety

As various electronic products have recently been diversified in shape, miniaturized, and slimmed, conventional batteries having a rectangular parallelepiped shape have been unable to efficiently utilize the inner space of the electronic products, which have various shapes and are miniaturized and slimmed.

Hence, the batteries are being manufactured in various shapes out of the rectangular parallelepiped shape to match a shape of the inner space of the electronic products, in which the batteries are accommodated, and a stepped battery is provided as one of these.

An example of the stepped battery is described in detail in a prior art document below (Korean Patent Publication No. 10-2015-0007971).

However, there is a limitation in a stepped battery according to the related art that the shape thereof is not optimally implemented to match various shapes of the inner space within a system.

In addition, there are many cases in which a protection circuit module (PCM) or other circuit board has be essentially has to be used. Here, since a separate space is required for locating the PCM or other circuit board, it may be difficult to effectively locate the PCB or other circuit board in the limited space.

### PRIOR ART DOCUMENT

Korean Patent Publication No. 10-2015-0007971

### DISCLOSURE OF THE INVENTION

### Technical Problem

Accordingly, to solve the foregoing limitation, an object of the present invention is to provide a stepped battery capable of maximizing utilization of an inner space of a system and implementing an optimized battery shape.

### Technical Solution

According an aspect of the present invention, there is provided a stepped battery including a first cell and a plurality of second cells, which are stacked on one surface of the first cell and each of which has a width less than that of the first cell, wherein the second cells are disposed to be spaced apart from each other.

### Advantageous Effects

The stepped battery according to the present invention may include the first cell and the plurality of second cells, which are stacked on the one surface of the first cell and each of which has the width less than that of the first cell. Here, the second cells may be disposed to be spaced apart from each other. Therefore, the inner space of the system may be maximized in utilization to implement the optimized battery shape.

### BRIEF DESCRIPTION OF THE DRAWINGS

FIG. 1 is a perspective view of a stepped battery according to Embodiment 1 of the present invention.

FIG. 2 is a front view of the stepped battery according to Embodiment 1 of the present invention.

FIG. 3 is a side view of the stepped battery according to Embodiment 1 of the present invention.

FIG. 4 is a front view of a stepped battery according to Embodiment 2 of the present invention.

FIG. 5 is a front view of a stepped battery according to Embodiment 3 of the present invention.

FIG. 6 is a plane view of the stepped battery according to Embodiment 3 of the present invention.

### MODE FOR CARRYING OUT THE INVENTION

Hereinafter, preferred embodiments of the present invention will be described in more detail with reference to the accompanying drawings. However, the present invention is not restricted or limited to Embodiments below.

### Embodiment 1

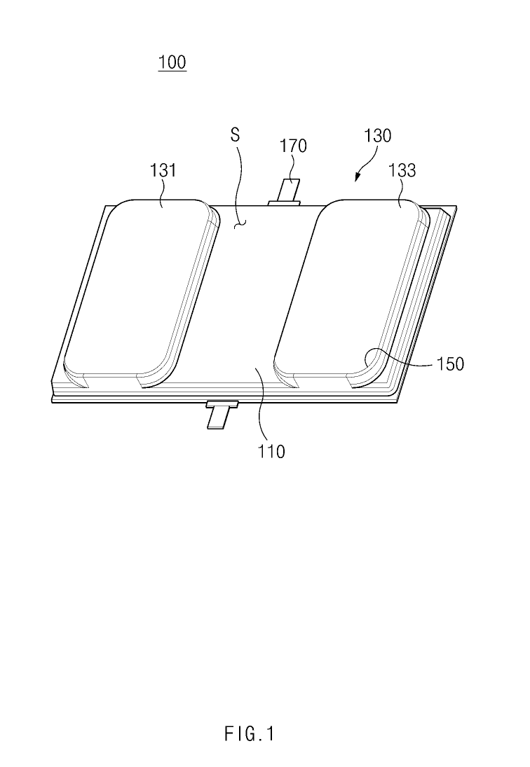

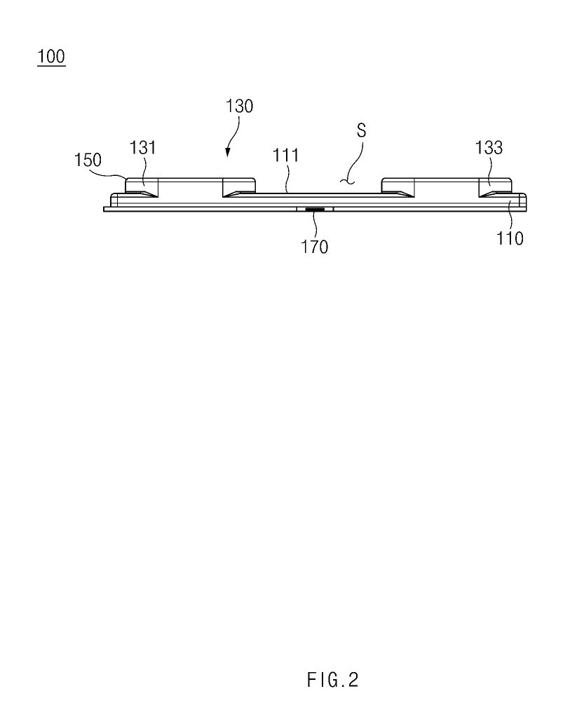

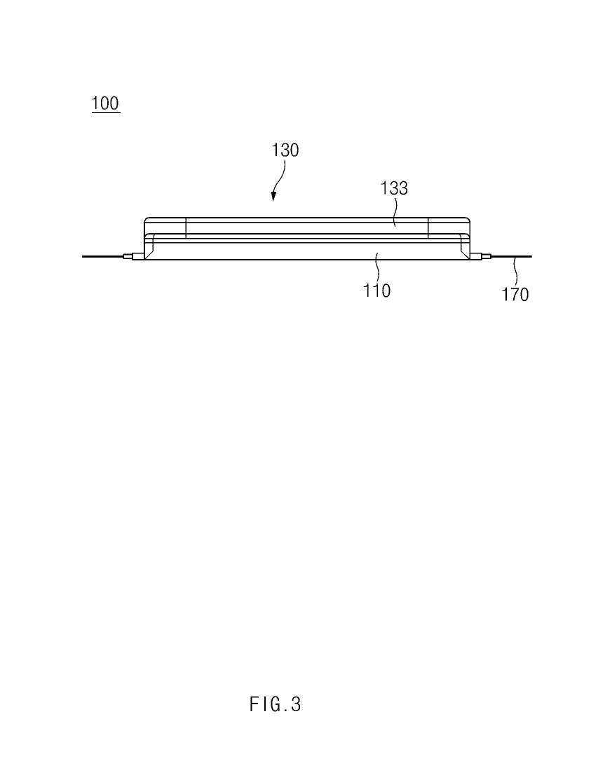

FIG. 1 is a perspective view of a stepped battery according to Embodiment 1 of the present invention. FIG. 2 is a front view of the stepped battery according to Embodiment 1 of the present invention. FIG. 3 is a side view of a stepped battery according to Embodiment 1 of the present invention.

Hereinafter, a stepped battery according to Embodiment 1 will be described with reference to FIGS. 1 to 3.

A stepped battery 100 according to Embodiment 1 includes a first cell 110 and a second cell 130.

The first cell 110 may be a cell constituting a base. Also, the first cell 110 may be a cell that is disposed under the second cell 130 that will be described below.

The second cell 130 may have a width less than that of the first cell 110 and be stacked on one surface 111 of the first cell 110. The second cell 130 may include a plurality of second cells 130 disposed on the one surface 111 of the first cell 110.

FIGS. 1 to 3 illustrate two second cells 130 disposed on the one surface 111 of the first cell, i.e., a top surface of the first cell 110. For convenience, the second cell that is disposed at a left side in FIG. 2 may be called a left second cell 131, and the second cell that is disposed at a right side in FIG. 2 may be called a right second cell 133.

In the stepped battery 100 according to Embodiment 1, the second cells 130 may be disposed to be spaced apart from each other on the one surface 111 of the first cell 110. Referring to FIG. 2, the second cell 130 may include the left second cell 131 and the right second cell 133, which are disposed to be horizontally spaced apart from each other.

A spaced space S may be defined between the second cells 130 disposed to be spaced from each other. In FIGS. 1 and 2, the spaced space S defined between the left second cell 131 and the right second cell 133 is illustrated.

In the stepped battery 100 according to Embodiment 1 of the present invention, when the second cells 130 are disposed to be spaced apart from each other as illustrated above, an inner space of a system may be maximized in utilization.

For example, when the stepped battery 100 is inserted into the system including a protrusion (not shown) protruding towards the inside of the central portion of the stepped battery 100, the protrusion may be accommodated in the spaced space S of the stepped battery 100 according to Embodiment 1. Thus, the inner space of the system may be maximally utilized without having a surplus space to maximize the utilization of the inner space.

Referring to FIGS. 1 and 2, at least one edge of the first cell 110 or the second cell 130 may be rounded. When the edge 150 is rounded as described above, internal structures of the system may be more protected.

If the edge 150 is sharp, the internal components of the system may be damaged or scratched. Also, the sharp edge may cause injury to a person that handles the battery 100 or may damage the treatment device.

In the stepped battery 100 according to Embodiment 1 of the present invention, the plurality of second cells may have the same size and weight as each other. In this case, since pressures applied to the different portions (the left and right portions) of the first cell 110 are the same, the stepped battery 100 may be balanced.

That is, if the pressures applied to the left and right portions of the first cell 110 are different from each other because the second cells 131 and 133 have sizes and weights different from each other, the balance of force is lost to cause abnormality of the first cell 110.

Also, if the internal components of the cell move from a side to which a large pressure is applied to a side to which a small pressure is allied, an abnormal operation of the battery may occur.

### Embodiment 2

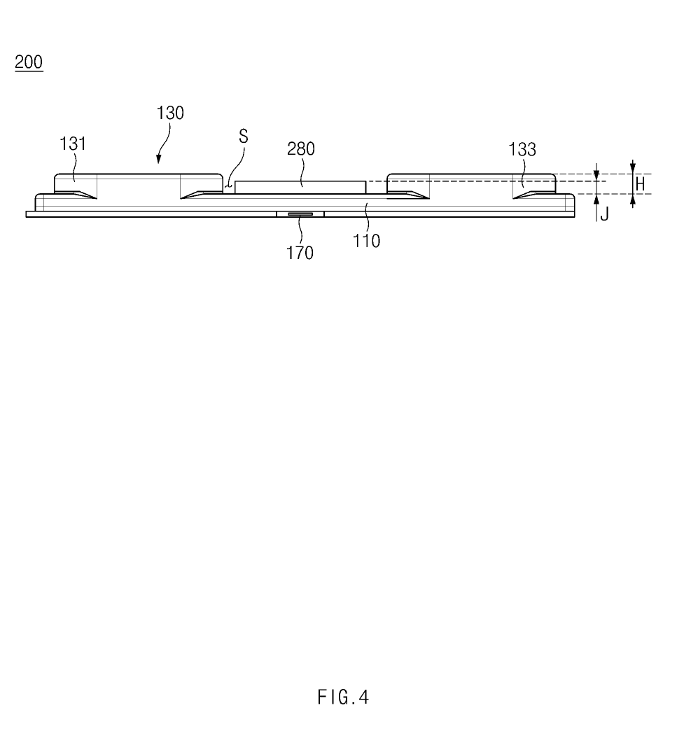

FIG. 4 is a front view of a stepped battery according to Embodiment 2 of the present invention.

The stepped battery according to Embodiment 2 of the present invention has a configuration similar to that of the stepped battery according to Embodiment 1 described above except that a protection circuit module is further provided.

For reference, the same (or corresponding) reference numeral will be given to the same (or corresponding) components as those described above, and thus duplicated descriptions thereof will be omitted.

Hereinafter, a stepped battery according to Embodiment 2 will be described with reference to FIG. 4.

As illustrated in FIG. 4, a stepped battery 200 according to Embodiment 2 of the present invention may include a protection circuit module 280 in a spaced space S thereof. Here, a constituent disposed in the spaced space S is not limited to the protection circuit module 280. Alternatively, other circuit board may be disposed in the spaced space S.

Since the protection circuit module 280 disposed in the spaced space S is mounted on the battery without occupying a separate space in the system into which the stepped battery 200 is inserted, an inner space of the system may be minimized and thus more effectively utilized.

Also, in the stepped battery 200 according to Embodiment 2, the protection circuit module 280 may have a height J equal to or less than a stepped height H of a second cell 130. That is, the second cell 130 may have the height H equal to or greater than that J of the protection circuit module 280. When the protection circuit module 280 is provided as described above, the protection circuit module 280 may be protected against an external object.

This is a similar principle as if a soldier hiding in a trench can be protected against flying bullets during the war. Since the protection circuit module 280 is disposed in the spaced space S that is recessed between left and right second cells 131 and 133, the protection circuit module 280 may be protected against the external object.

### Embodiment 3

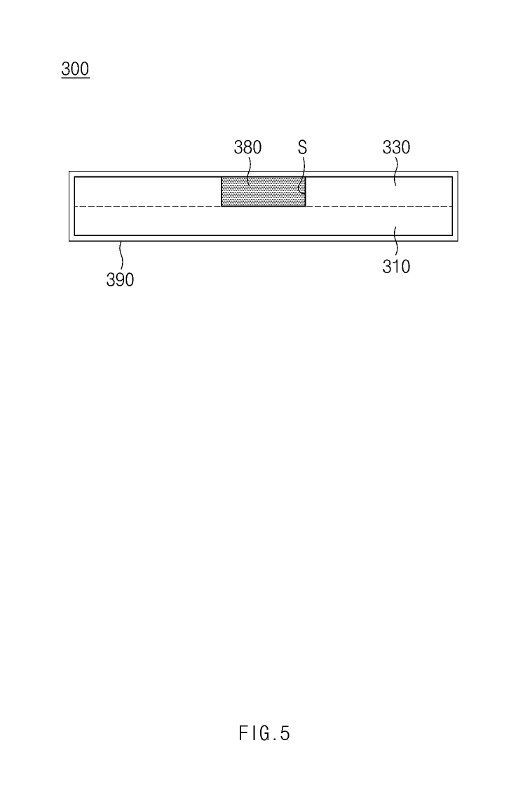

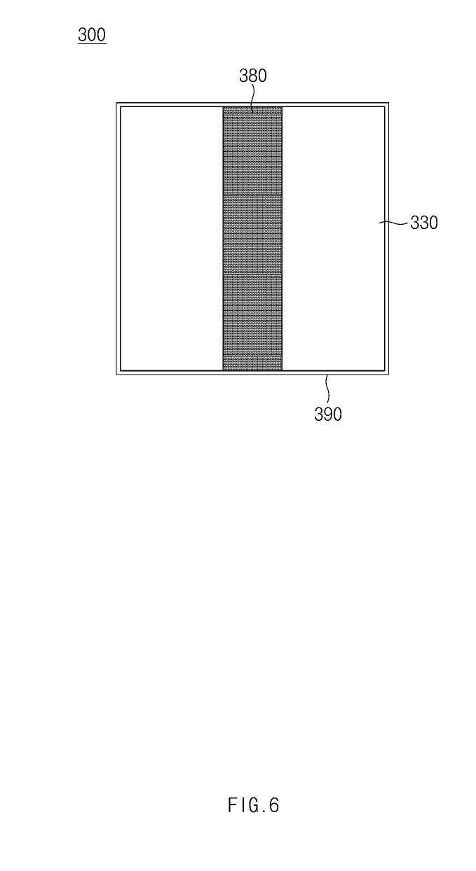

FIG. 5 is a front view of a stepped battery according to Embodiment 3 of the present invention. FIG. 6 is a plane view of the stepped battery according to Embodiment 3 of the present invention.

The stepped battery according to Embodiment 3 of the present invention has a configuration similar to that of the stepped battery according to Embodiment 1 described above except that a protection circuit module is further provided.

For reference, the same (or corresponding) reference numeral will be given to the same (or corresponding) components as those described above, and thus duplicate descriptions thereof will be omitted.

Hereinafter, a stepped battery according to Embodiment 3 will be described with reference to FIGS. 5 and 6.

As illustrated in FIGS. 5 and 6, a stepped battery 300 according to Embodiment 3 of the present invention may include a circuit board 380 disposed in a spaced space S thereof. Here, a constituent disposed in the spaced space S is not limited to the circuit board 380. Alternatively, a protection circuit module or the like may be disposed in the spaced space S.

The circuit board 380 may have a size corresponding to that of the spaced space S. Particularly, as illustrated in FIGS. 5 and 6, the circuit board 380 may have a size that matches that of the spaced space S. In this case, the circuit board 380 may not be separated from the stepped battery 300 by friction therebetween even without having a separate fixing device for fixing the circuit board 380. In this manner, the stepped battery 300 may be integrated.

Also, when the circuit board 380 is mounted to fill the spaced space S, an outer case 390 may be maintained in a flat shape without being waved or stepped to realize the battery that is more improved in terms of an outer appearance and practicability thereof.

1. A stepped battery comprising:
a first cell; and
a plurality of second cells stacked on one surface of the first cell, and each of which has a width less than that of the first cell,
wherein the second cells are disposed to be spaced apart from each other.

2. The stepped battery of claim 1, wherein a spaced space is defined between the second cells disposed to be spaced apart from each other.

3. The stepped battery of claim 1, wherein the plurality of second cells have the same size and weight as each other.

4. The stepped battery of claim 1, wherein the first cell or the second cell has a rounded edge.

5. The stepped battery of claim 2, wherein a protection circuit module (PCM) or a circuit board is disposed in the spaced space.

6. The stepped battery of claim 5, wherein the second cell has a height equal to or greater than that of the protection circuit module or the circuit board.

7. The stepped battery of claim 5, wherein the protection circuit module or the circuit board has a size corresponding to that of the spaced space.
